(19) United States
(12) Patent Application Publication
(10) Pub. No.: US 2014/0301761 A1
(43) Pub. Date: Oct. 9, 2014

(54) MULTILAYER METAL MEMBER FOR IMAGE FIXATION

(71) Applicants: SYNZTEC CO., LTD., Tokyo (JP); NOK CORPORATION, Tokyo (JP)

(72) Inventors: Shingo SUGIYAMA, Kanagawa (JP); Akira NISHIDA, Kanagawa (JP); Masaya SUZUKI, Kanagawa (JP); Minoru TAKEDA, Saitama (JP)

(73) Assignees: SYNZTEC CO., LTD., Tokyo (JP); NOK CORPORATION, Tokyo (JP)

(21) Appl. No.: 14/243,373

(22) Filed: Apr. 2, 2014

(30) Foreign Application Priority Data
Apr. 3, 2013 (JP) 2013-077999
Apr. 1, 2014 (JP) 2014-75654

(51) Int. Cl. G03G 15/20

(52) U.S. Cl. CPC G03G 15/2057
USPC 399/333

(57) ABSTRACT

The invention provides a multilayer metal member for image fixation which does not readily undergo breakage due to bending stress during use thereof and which has improved durability. The multilayer metal member includes a metal substrate formed of at least three laminated metal layers, and a fluororesin layer disposed on the metal substrate, wherein the metal substrate has a first layer which is an electrocast seamless belt formed of nickel or a nickel alloy, a second layer which is an electrocast seamless belt formed of a metal having a Young's modulus smaller than that of the first layer, and a third layer formed of a metal having a corrosion resistance higher than that of the second layer; and the ratio (y) of the thickness of the third layer to that of the first layer satisfies the following formula:

y(x)≦−7.5x+3.015,

including the ratio (x) of the thickness of the second layer to the total thickness of the metal substrate.

The entire disclosure of Japanese Patent Application No. 2013-077999 filed on Apr. 3, 2013 is expressly incorporated by reference herein.

### BACKGROUND OF THE INVENTION

1. Field of the Invention

The present invention relates to a multilayer metal member employed as a fixation member such as a fixation belt or a fixation roller and, more particularly, to a multilayer metal member which is particularly suitable for a fixation belt of a fixation unit employed in an image-forming apparatus such as a copying machine, a facsimile machine, or a laser beam printer.

2. Background Art

Electrophotographic image-forming apparatuses are equipped with a fixation unit, by which a toner image is fixed on a recording paper sheet. One type of fixation unit includes an endless fixation belt, and a pressure roller disposed so as to face opposite the fixation belt. Such a fixation belt is employed so that a recording medium is passed through a nip portion between the fixation belt and the pressure roller opposite the fixation belt, whereby an unfixed toner image is fixed onto the recording medium by means of heat and pressure.

Currently employed fixation belts include a fixation belt formed of a high-resistant polymer (e.g., polyimide resin) and a metal belt formed of high-thermal-conductivity material such as nickel or nickel alloy (see, for example, Patent Documents 1 and 2). However, a fixation belt formed of polyimide resin or the like disclosed in Patent document 1 has insufficient thermal conductivity, and difficulty is encountered in enhancing image fixation speed. Also, a fixation belt formed of nickel or the like disclosed in Patent Document 2 has poor flex resistance, although the fixation belt has excellent dimensional stability and other properties.

In order to enhance flex resistance and strength, there has been proposed a fixation belt formed of an electrocast layer having three or more layers and having a structure in which high-hardness electrocast nickel layer is sandwiched by low-hardness electrocast nickel layers (see Patent Document 3).

However, as printing speed and copying speed have increased in recent years, breakage of a fixation belt after rotation with bending readily occurs. Thus, there is demand for a fixation belt having further improved durability.

Patent Document 1: Japanese Patent Application Laid-Open (kokai) No. 2010-221647
Patent Document 2: Japanese Patent Application Laid-Open (kokai) No. 2011-150230

### Patent Document 3: Japanese Patent No. 4344189

### SUMMARY OF THE INVENTION

In view of the foregoing, an object of the present invention is to provide a multilayer metal member for image fixation which does not readily undergo breakage due to bending stress during use thereof and which has improved durability.

In one aspect of the present invention for attaining the object, there is provided a multilayer metal member for image fixation comprising a metal substrate formed of at least three laminated metal layers, and a fluororesin layer disposed on the metal substrate, wherein the metal substrate has a first layer which is an electrocast seamless belt formed of nickel or a nickel alloy, a second layer which is an electrocast seamless belt formed of a metal having a Young's modulus smaller than that of the first layer, and a third layer formed of a metal having a corrosion resistance higher than that of the second layer; and the ratio (y) of the thickness of the third layer to that of the first layer satisfies the following formula 1:

y(x)≦−7.5x+3.015, [F1]

including the ratio (x) of the thickness of the second layer to the total thickness of the metal substrate.

The multilayer metal member for image fixation according to the present invention has a laminate structure including a plurality of metal layers which are electrocast seamless belts differing in Young's modulus values, wherein the thickness values of the metal layers are adjusted so as to fall within specific ranges. Thus, the multilayer metal member for image fixation does not readily undergo breakage due to bending stress during use thereof and has improved durability.

The second layer is preferably a plating layer formed of copper or a copper alloy.

Through use of copper or a copper alloy, which has a Young's modulus smaller than that of nickel or a nickel alloy, bending stress during use can be more effectively relaxed.

The third layer is preferably a plating layer formed of nickel or a nickel alloy.

Through use of a plating layer formed of nickel or a nickel alloy, durability of the multilayer metal member can be further enhanced.

The metal substrate preferably has a laminate structure in which the second layer is sandwiched by the first layer and the third layer.

When the metal substrate has a laminate structure in which the second layer in the form of an electrocast seamless belt formed of a metal having a small Young's modulus is sandwiched by the first layer and the third layer, breakage of the multilayer metal member due to bending stress during use can be further suppressed, and durability of the multilayer metal member can be further enhanced.

The multilayer metal member for image fixation preferably has an elastic layer disposed on the metal substrate.

When such a multilayer metal member having an elastic layer is employed as a fixation member of a fixation unit, excellent fixability and durability can be attained.

According to the present invention, the multilayer metal member for image fixation has a laminate structure including a plurality of metal layers which are electrocast seamless belts differing in Young's modulus values, wherein the thickness values of the metal layers are adjusted so as to fall within specific ranges. Thus, the multilayer metal member for image fixation does not readily undergo breakage due to bending stress during use thereof and has improved durability.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1A is a cross-section of a multilayer metal member for image fixation according to Embodiment 1;

FIG. 1B is an enlarged view of the cross-section of FIG. 1A;

FIG. 2 is a cross-section of the multilayer metal member for image fixation according to Embodiment 1 employed as a fixation belt;

FIG. 3 is a cross-section of the multilayer metal member for image fixation according to Embodiment 1 employed as a fixation belt;

FIG. 4 is a cross-section of the multilayer metal member for image fixation according to Embodiment 1 employed as a fixation belt;

FIG. 5 is a graph showing the relationship between the number of swing cycles until the metal substrates (samples 1 to 12 and comparative samples 1 to 7) were broken and the ratio of the thickness of the third layer to that of the first layer; and

FIG. 6 is a graph showing the relationship between the ratio (y) of the thickness of the third layer to that of the first layer of each of samples 1 to 12 and comparative samples 1 to 7 and the ratio (x) of the thickness of the second layer to the total thickness of the metal substrate.

### DETAILED DESCRIPTION OF PREFERRED EMBODIMENTS

Embodiments of the present invention will next be described in detail.

### Embodiment 1

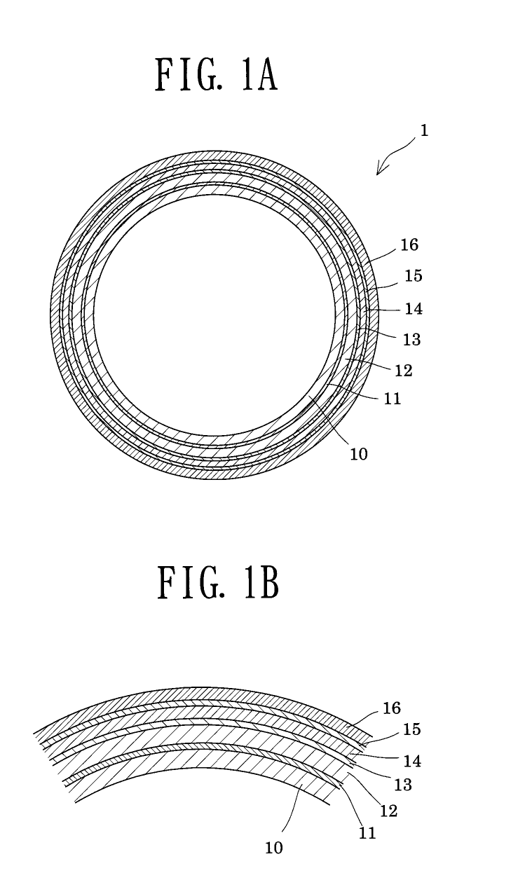

The multilayer metal member for image fixation is employed as a fixation member of a fixation unit of an image-forming apparatus; e.g., a fixation belt or a fixation roller. FIG. 1A is a cross-section of a multilayer metal member for image fixation according to Embodiment 1, and FIG. 1B is an enlarged view of the cross-section of FIG. 1A. A multilayer metal member for image fixation 1 has a hollow cylindrical shape. As shown in FIG. 1A, the multilayer metal member for image fixation 1 has a metal substrate including a first layer 10 which is an electrocast seamless belt formed of nickel or a nickel alloy, a second layer 11 which is an electrocast seamless belt formed of a metal having a Young's modulus smaller than that of the first layer 10, and a third layer 12 formed of a metal having a corrosion resistance higher than that of the second layer 11. On the third layer 12, an elastic layer 14 is disposed by the mediation of a first adhesion layer 13. On the elastic layer 14, a fluororesin layer 16 is disposed by the mediation of a second adhesion layer 15.

Specifically, the first layer 10 is formed of an electrocast nickel. The concept “electrocast nickel” encompasses electrocast single-element nickel and an electrocast nickel alloy containing at least one element selected from among phosphorus, iron, cobalt, and manganese. In Embodiment 1, an electrocast nickel-phosphorus alloy is employed as an electrocast nickel.

The second layer 11 is formed of a metal having a Young's modulus smaller than that of nickel or a nickel alloy. In Embodiment 1, the second layer 11 is formed of an electrocast copper. The concept “electrocast copper” encompasses electrocast single-element copper and an electrocast copper alloy containing at least one element selected from among silver, gold, and zinc. The Young's modulus of the second layer 11 is 80% or less the Young's modulus of nickel or a nickel alloy, preferably 70% or less. Specifically, since nickel has a Young's modulus of about 155 GPa, the second layer 11 has a Young's modulus of 124 GPa or less, preferably 103 GPa or less.

The third layer 12 is formed of a metal having a corrosion resistance higher than that of the second layer 11. In Embodiment 1, the third layer 12 is formed of an electrocast nickel-phosphorus alloy. Through formation of the third layer 12 from a metal having high corrosion resistance, formation of oxide film on the surface of the second layer 11 is prevented.

The multilayer metal member for image fixation 1 of Embodiment 1 has a laminate structure in which the second layer 11 formed of an electrocast copper having a Young's modulus smaller than that of nickel is sandwiched by the first layer 10 and the third layer 12 formed of an electrocast nickel having excellent durability. Through adjusting thickness ratios involving the first layer 10, the second layer 11, and the third layer 12 to fall within specific ranges, flex resistance of the multilayer metal member for image fixation 1 can be remarkably enhanced. This feature will be described in detail. Specifically, the ratio (y) of the thickness of the third layer 12 to that of the first layer 10 satisfies the following formula 1:

y(x)≦−7.5x+3.015, [F1]

including the ratio (x) of the thickness of the second layer 11 to the total thickness of the metal substrate.

Thus, although the feature will be described in detail, the flex resistance of the multilayer metal member for image fixation 1 can be remarkably enhanced as compared with conventional ones.

In addition to formula 1, the multilayer metal member of the present invention preferably satisfies the following formula 2:

y(x)≧2.85x+0.1675, [F2]

and the ratio (x) of the thickness of the second layer 11 to the total thickness of the metal substrate is preferably 0.025 or more. Through employment of the preferred mode, the multilayer metal member for image fixation 1 has a flex resistance which is 1.5 times or more that of a metal substrate having the same thickness as that of the metal substrate composed of the first layer 10, the second layer 11, and the third layer 12.

Furthermore, the ratio (y) of the thickness of the third layer 12 to that of the first layer 10 preferably satisfies the following formulas 3 and 4:

y(x)≦−7.1x+2.065 and [F3]

y(x)≧4.2x+0.37, [F4]

including the ratio (x) of the thickness of the second layer 11 to the total thickness of the metal substrate, and preferably has a ratio (x) of the thickness of the second layer 11 to the total thickness of the metal substrate of 0.025 or more. Through employment of the preferred mode, the flex resistance of the multilayer metal member for image fixation 1 is further enhanced, and the flex resistance is enhanced to 2.0 times or more that of a monolayer metal substrate having the same thickness as that of the metal substrate composed of the first layer 10, the second layer 11, and the third layer 12.

Also, in Embodiment 1, since the second layer 11 is very thin, the electrolysis time for forming electrocast copper, which would otherwise be a long time, can be shortened to about half the time or shorter. Thus, even when different types of metal layers are stacked, a longer production time is not required, thereby reducing production cost.

Embodiment 1 of the present invention will be described in more detail. As described above, the first layer 10 is an electrocast seamless belt formed of nickel or a nickel alloy (hereinafter may be referred to as “electrocast nickel seamless belt”). When the first layer 10 is an electrocast nickel seamless belt, the multilayer metal member has improved durability and a favorable surface having high dimensional stability. The nickel alloy is preferably a nickel-phosphorus alloy, more preferably a nickel-phosphorus alloy having a phosphorus content of 0.05 mass % to 1 mass %. When the first layer 10 formed of an electrocast nickel seamless belt has a phosphorus content less than 0.05 mass %, durability of the first layer 10 may fail to be sufficiently enhanced, whereas when the phosphorus content is in excess of 1 mass %, flexibility of the first layer 10 may be impaired.

The first layer 10 made of an electrocast nickel seamless belt is generally formed through electrocasting, on a cylindrical substrate made of stainless steel, brass, aluminum, or the like, by use of a nickel electrocasting bath; for example, a Watts bath containing as a predominant component nickel sulfate or nickel chloride, or a sulfamate bath containing as a predominant component nickel sulfamate. In electrocasting, a plating substrate is thick-plated, and the thus-formed metal layer is removed from the substrate, to thereby provide a metal product.

In the case where the plating substrate is made of a non-conducting material such as silicone resin or gypsum, the non-conducting substrate is subjected to a conducting-property-imparting treatment by use of graphite or copper powder, or through silver mirror reaction, sputtering, or a similar process. When a metallic electrocasting substrate is used, the surface of the substrate is preferably subjected to a release-facilitating treatment, for example, forming a release film such as oxide film, compound film, or graphite coating film, in order to facilitate removing the formed nickel plating film from the substrate.

The nickel electrocasting bath contains a nickel ion source, an anode-dissolving agent, a pH buffer, and other additives. Examples of the nickel ion source include nickel sulfamate, nickel sulfate, and nickel chloride. In the case of Watts bath, nickel chloride serves as an anode-dissolving agent. In the case of other nickel baths, ammonium chloride, nickel bromide, and other compounds are used. The nickel plating is generally performed at a pH of 3.0 to 6.2. In order to adjust the pH to fall within the preferred range, a pH buffer such as boric acid, formic acid, nickel acetate, or the like is used. Other additives employed in the nickel electrocasting bath include a brightener, a pit-corrosion-preventing agent, and an internal stress-reducing agent, for the purposes of smoothing, pit corrosion prevention, reducing crystal grain size, reduction of residual stress, etc.

The nickel electrocasting bath is preferably a sulfamate bath. One exemplary composition of the sulfamate bath includes nickel sulfamate tetrahydrate (300 to 600 g/L), nickel chloride (0 to 30 g/L), boric acid (20 to 40 g/L), a surfactant (appropriate amount), and a brightener (appropriate amount). The pH is 2.5 to 5.0, preferably 3.5 to 4.7, and the bath temperature is 20 to 65° C., preferably 40 to 60° C. The first layer 10 formed of an electrocast nickel alloy may be produced in a nickel electrocasting bath appropriately containing a water-soluble phosphorus-containing acid salt (e.g., sodium phosphite), a metal sulfamate salt (e.g., ferrous sulfamate, cobalt sulfamate, or manganese sulfamate), palladium sulfamate, etc. Notably, when a nickel electrocasting bath appropriately containing a water-soluble phosphorus-containing acid salt, a metal sulfamate salt (e.g., ferrous sulfamate, cobalt sulfamate, or manganese sulfamate), palladium sulfamate, etc. is used, there can be formed an electrocast seamless belt formed of a nickel alloy containing one or more elements selected from among phosphorus, iron, cobalt, manganese, and palladium. Needless to say, the first layer 10 may be formed from the nickel alloy. The method for producing the first layer 10 is not limited to electrocasting.

The first layer 10 can be formed from an electrocast nickel-phosphorus alloy through electrocasting by use of the aforementioned nickel electrocasting bath, in particular, a phosphorus-containing nickel sulfamate bath, under the aforementioned conditions. In the case where the first layer 10 is formed from an electrocast nickel-phosphorus alloy, durability; in particular, a thermal fatigue characteristic of the multilayer metal member for image fixation 1, is improved.

The second layer 11 is formed of a metal having a Young's modulus smaller than that of an electrocast nickel seamless belt. From the viewpoints of adhesion to the first layer 10 and production of an electrocast seamless belt, the metal is preferably copper or a copper alloy. As described above, the ratio (x) of the thickness of the second layer 11 to the total thickness of the metal substrate is preferably 0.025 or more, and the ratio (y) of the thickness of the third layer 12 to that of the first layer 10 preferably satisfies the following formula 1 (y(x)≦−7.5x+3.015), including the ratio (x) of the thickness of the second layer 11 to the total thickness of the metal substrate. When the ratio (y) of the thickness of the third layer 12 to that of the first layer 10 does not satisfy formula 1, the effects of enhancing flex resistance and durability cannot be fully attained.

Preferably, the second layer 11 is produced through electroplating. In one specific procedure, a plating film is formed on the surface of the first layer 10 by use of a plating bath, to thereby from the second layer 11. By virtue of the thus-formed second layer 11, adhesion to the first layer 10 can be enhanced. In the case where the second layer 11 is formed of copper, in one specific procedure, a copper plating film is formed by use of a copper plating bath. Examples of the copper plating bath include a copper sulfate plating bath, a copper pyrophosphate plating bath, a copper cyanide plating bath, and a copper electroless plating bath. Of these, a copper sulfate plating bath is preferably used. One preferred copper sulfate plating bath comprises copper sulfate (150 to 250 g/L), sulfuric acid (30 to 150 g/L), hydrochloric acid (0.125 to 0.25 mL/L), and a brightener (appropriate amount). Alternatively, the second layer 11 may be formed through electroless plating, physical vapor deposition, chemical vapor deposition, or a similar technique.

The third layer 12 is formed of a metal having a corrosion resistance higher than that of the second layer 11. Examples of the high-corrosion-resistance metal include gold, silver, and nickel or a nickel alloy. Of these, nickel or a nickel alloy is preferred. The third layer 12 is preferably formed through electroplating. In one specific procedure, a plating film is formed on the surface of the second layer 11 by use of a plating bath, to thereby form the third layer 12. In this case, the third layer 12 is preferably formed so that contact of the surface of the second layer 11 with air is prevented to the maximum possible extent. By virtue of the thus-formed third layer 12, corrosion of the second layer 11 can be more effectively prevented. Also, when the third layer 12 is formed through electroplating, adhesion between the third layer 12 and the second layer 11 can be enhanced. Notably, since the third layer 12 of Embodiment 1 is formed of an electrocast nickel-phosphorus alloy, the third layer 12 may be formed through the same method as employed in formation of the first layer 10. In the case where the third layer 12 is formed of nickel or a nickel alloy such as an Ni—Fe alloy, an Ni—Co alloy, an Ni—Co—P alloy, or an Ni—Mn alloy, the third layer 12 can be formed through the same method as employed in formation of the first layer 10, with appropriate appropriate modification of an electrode or the like. The third layer 12 may also be formed through electroless plating, physical vapor deposition, chemical vapor deposition, or a similar technique.

The total thickness of the metal substrate; i.e., the sum of the thicknesses of the first layer 10, the second layer 11, and the third layer 12, is preferably 20 to 60 μm, more preferably 25 to 50 μm. When the thickness is less than 20 μm, the strength of the multilayer metal member cannot be ensured, whereas when the thickness is in excess of 60 μm, bending stress increases, and durability tends to decrease.

In order to attain strong adhesion to the elastic layer 14, the first adhesion layer 13 is preferably formed from a silicone-base adhesive, and preferably has a thickness of 1 to 15 μm.

The elastic layer 14 is preferably formed of a material having high heat resistance. Examples of the material include silicone rubber, fluororubber, and urethane rubber. Of these, silicone rubber is particularly preferred. The thickness of the elastic layer 14 is, for example, 20 to 1,000 μm, preferably 50 to 500 μm. When the elastic layer has such a thickness, toner fixability and image quality are enhanced.

The second adhesion layer 15 preferably employs an adhesive containing PFA particles for strongly bonding to the fluororesin layer 16. So long as adhesion can be ensured, the second adhesion layer 15 has as thin a thickness as possible. For example, a thickness of 1 μm to 20 μm is preferred, with 1 μm to 15 μm being more preferred.

The fluororesin layer 16 is formed of a releasable fluororesin, and examples thereof include perfluoroalkoxy fluororesin (PFA), polytetrafluoroethylene (PTFE), tetrafluoroethylene-hexafluoropropylene copolymer (FEP), and tetrafluoroethylene-ethylene copolymer (ETFE). Among such materials, PFA tube is preferred, with heat-shrinkable PFA tube being more preferred. The thickness of the fluororesin layer 16 is, for example, 1 to 150 μm, preferably 5 to 30 μm. When the fluororesin layer 16 has a thickness of 1 to 150 μm, and the second adhesion layer 15 has a thickness of 1 μm to 20 μm, toner fixability and image quality can be enhanced.

The multilayer metal member for image fixation 1 of Embodiment 1 has an endless-belt-form metal substrate having a multilayer structure consisting of three layers. However, alternatively, the metal substrate may include four or more layers.

As described above, the multilayer metal member for image fixation 1 may be employed mainly as a fixation belt of an image-fixation apparatus. In this case, since the fixation belt is formed of the multilayer metal member for image fixation 1, breakage due to bending stress can be suppressed even under rotation with bending, leading to enhancement in durability.

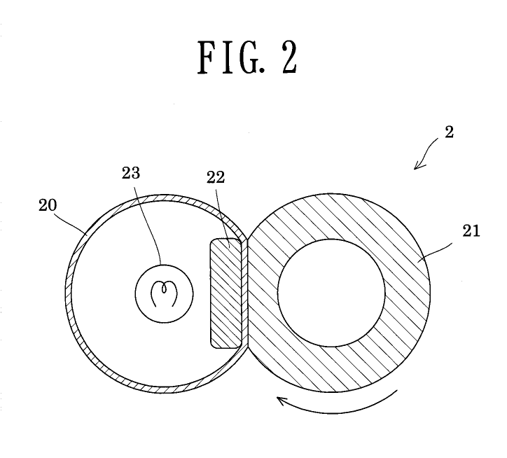

FIGS. 2 to 4 are cross-sections of fixation units each employing the multilayer metal member for image fixation 1 as a fixation belt. Such a fixation unit is employed in an image-forming apparatus and fixes an unfixed toner image onto a recording medium through heat and pressure.

The fixation apparatus 2 shown in FIG. 2 has a fixation belt 20, a pressure roller 21 disposed so as to face opposite the fixation belt 20, and a pressure member 22 that outwardly presses the fixation belt 20 against the opposite pressure roller 21, to thereby form a specific nip portion. A heating means 23 for heating the fixation belt 20 to a predetermined temperature is disposed inside the fixation belt 20.

The pressure member 22 is formed of an elastic material such as rubber. The elastic pressure member may be coated with an optional layer such as a fluororesin layer.

The pressure roller 21 consists of a core made of metal or the like, and an elastic layer which is made of rubber or the like and which is formed on the peripheral surface of the core. The outer surface of the elastic layer may optionally be provided with a release layer formed of a fluororesin or the like.

No particular limitation is imposed on the heating means 23, so long as it can heat the fixation belt 20. Examples of the heating means include a halogen heater, a Nichrome heater, an infrared heater, and an electromagnetic induction heater with an exciting coil (heat source).

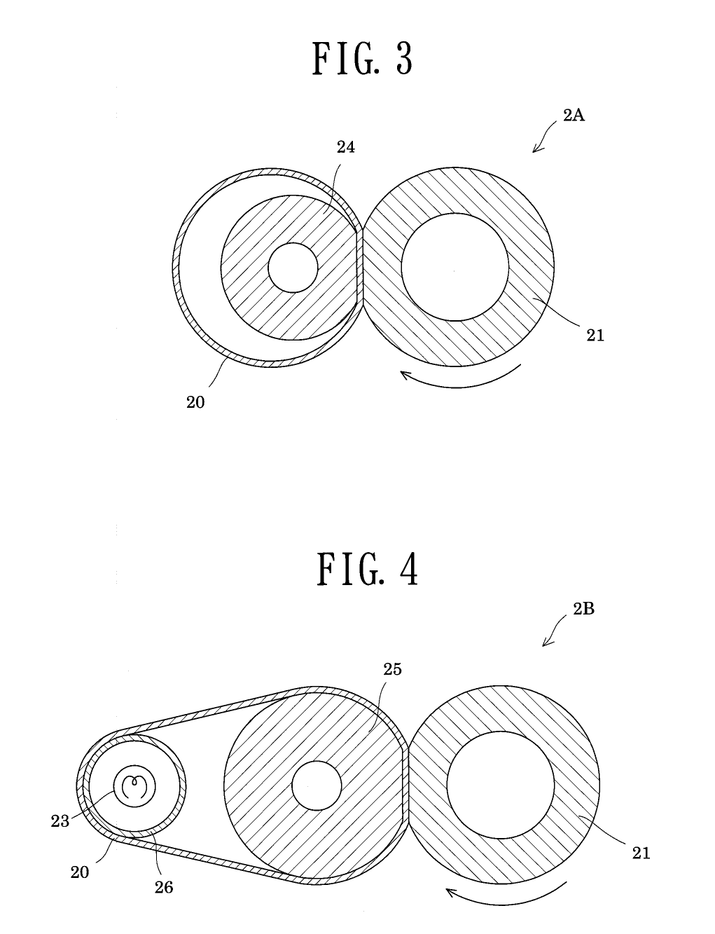

A fixation apparatus 2A shown in FIG. 3 has a fixation belt 20, a pressure roller 21 disposed so as to face opposite the fixation belt 20, and, instead of the pressure member 22, a fixation roller 24 that outwardly presses the fixation belt 20 against the pressure roller 21. A heating means for heating the fixation belt 20 (not illustrated) may be disposed outside the fixation belt 20.

A fixation apparatus 2B shown in FIG. 4 has a fixation belt 20, a pressure roller 21 disposed so as to face opposite the fixation belt 20, an inner roller 25 that outwardly presses the fixation belt 20 against the pressure roller 21, and a heating roller 26 inside which heating means is disposed. The inner roller 25 and the heating roller 26 are disposed in the fixation belt 20, and the fixation belt 20 is rotated by means of the pressure roller 21.

As described above, no particular limitation is imposed on the mode of use of the fixation belt. Although the multilayer metal member for image fixation 1 of the present invention is suitably employed in the aforementioned fixation belt, the multilayer metal member may be employed in a transfer/fixation belt for sequential image transfer and fixation, or another belt.

### EXAMPLES

The present invention will next be described in detail by way of examples, which should not be construed as limiting the invention thereto. The configuration of the metal substrate of each of samples 1 to 12 and Comparative Examples 1 to 7 shown in Table 1.

### Samples 1 to 12

Samples 1 to 12 of the metal substrate forming the multilayer metal member for image fixation 1 were produced through the following procedure.

A nickel-phosphorus sulfamate electrocast bath of interest was prepared from nickel sulfamate (500 g/L), sodium phosphite (150 mg/L), boric acid (30 g/L), trisodium naphthalene-1,3,6-trisulfonate (1.0 g/L) serving as a primary brightener, and 2-butyne-1,4-diol (20 mg/L) serving as a secondary brightener.

While the electrocast bath was maintained at 60° C. and a pH of 4.5, electrocasting was performed with a stainless steel cylindrical substrate (outer diameter: 30 mm) serving as a cathode, and a depolarized nickel serving as an anode at a current density of 16 A/dm², to thereby deposit, on the outer surface of the steel substrate, a metal layer. The metal layer was removed from the substrate, to thereby yield a first layer 10 formed of an electrocast nickel-phosphorus alloy film and having an inner diameter of 30 mm and a thickness shown in Table 1. The first layer 10 had a phosphorus content of 0.5 mass %.

On the first layer 10, a second layer 11 was formed from an electrocasting bath having the following composition. Specifically, a copper sulfate electrocasting bath of interest was prepared from copper sulfate (180 g/L), sulfuric acid (60 g/L), thiourea (0.04 g/L), and molasses (0.8 g/L). Then, the electrocasting bath was heated to and maintained at 45° C., and electrocasting was performed with the aforementioned electrodeposited metal layer serving as a cathode, and a Cu—P as an anode at a current density of 5 A/dm², to thereby form, on the first layer 10, a second layer 11 made of copper having a thickness shown in Table 1. The second layer 11 had a specific resistance of 1.7×10⁻⁸ Ω·m and a relative permeability of 1.6.

On the second layer 11, a third layer 12 made of an electrocast nickel-phosphorus alloy and having a thickness shown in Table 1 was formed in the same manner. The metal-deposited substrate was removed from the electroplating bath, and fins at both ends were cut away, to thereby produce a metal substrate of a 3-layer structure. The thus-produced metal substrates were employed as samples 1 to 12.

### Comparative Samples

Metal substrates each having a first layer, a second layer, and a third layer having thicknesses shown in Table 1 were formed through the same method as employed for producing samples 1 to 12, whereby comparative samples 1 to 6 were prepared. Also, a metal substrate formed only of a first layer having a thickness shown in Table 1 was produced through the same method as employed for producing samples 1 to 12, whereby comparative sample 7 was prepared.

TABLE 1

| | 1st | 2nd | 3rd | | | | No. of | |
|---|---|---|---|---|---|---|---|---|
| | layer | layer | layer | | | | swing | |
| | T1 | T2 | T3 | Total | T2/ | T3/ | cycles | |
| | μm | μm | μm | [μm] | total | T1 | to break | Score |
| Sample 1 | 19.5 | 1 | 19.5 | 40 | 0.025 | 1.00 | 108,300 | ◯◯ |
| Sample 2 | 29 | 2 | 9 | 40 | 0.05 | 0.31 | 49,354 | ◯ |
| Sample 3 | 24 | 2 | 14 | 40 | 0.05 | 0.58 | 68,074 | ◯◯ |
| Sample 4 | 19 | 2 | 19 | 40 | 0.05 | 1.00 | 103,405 | ◯◯ |
| Sample 5 | 14 | 2 | 24 | 40 | 0.05 | 1.71 | 61,267 | ◯◯ |
| Sample 6 | 11 | 2 | 29 | 42 | 0.05 | 2.64 | 42,000 | ◯ |
| Sample 7 | 20 | 6 | 14 | 40 | 0.15 | 0.70 | 44,000 | ◯ |
| Sample 8 | 17 | 6 | 17 | 40 | 0.15 | 1.00 | 63,706 | ◯◯ |
| Sample 9 | 13 | 6 | 21 | 40 | 0.15 | 1.62 | 44,000 | ◯ |
| Sample | 16 | 10 | 14 | 40 | 0.25 | 0.88 | 41,000 | ◯ |
| 10 | | | | | | | | |
| Sample | 15 | 10 | 15 | 40 | 0.25 | 1.00 | 48,194 | ◯ |
| 11 | | | | | | | | |
| Sample | 14 | 10 | 16 | 40 | 0.25 | 1.14 | 41,000 | ◯ |
| 12 | | | | | | | | |
| Comp. | 9 | 2 | 29 | 40 | 0.05 | 3.22 | 34,037 | Δ |
| sample 1 | | | | | | | | |
| Comp. | 11 | 6 | 23 | 40 | 0.15 | 2.09 | 34,000 | Δ |
| sample 2 | | | | | | | | |
| Comp. | 12.5 | 10 | 17.5 | 40 | 0.25 | 1.40 | 35,000 | Δ |
| sample 3 | | | | | | | | |
| Comp. | 12 | 16 | 12 | 40 | 0.40 | 1.00 | 27,075 | Δ |
| sample 4 | | | | | | | | |
| Comp. | 10 | 20 | 10 | 40 | 0.50 | 1.00 | 16,829 | X |
| sample 5 | | | | | | | | |
| Comp. | 5 | 30 | 5 | 40 | 0.75 | 1.00 | 7,751 | X |
| sample 6 | | | | | | | | |
| Comp. | 40 | 0 | 0 | 40 | 0 | 0 | 26,836 | X |
| sample 7 | | | | | | | | |

### Test Example 1

The metal substrate samples 1 to 12 and comparative samples 1 to 7 were subjected to a biaxial rotation test under heating by means of a biaxial heating rotation tester. Each of the metal substrate samples 1 to 12 and comparative samples 1 to 7 was cut into slips having a width of 15 mm. An end of the slip was polished by means of sand-paper (Nos. 600 and 1000). The absence of fins on the slip was checked by finger touching. Thus, rotational test samples were prepared.

The test conditions were as follows: load; 1.0 kg, pulley diameter (drive shaft); φ15, pulley diameter (follow shaft); φ4, test speed; 300 rpm, and test temperature; 175° C. The rotation test was performed in air. Table 1 shows the number of swing cycles until the metal substrates (samples 1 to 12 and comparative samples 1 to 7) were broken (hereinafter the number may be referred to as “rotation endurance number”), and the evaluation of the metal substrate samples. In Table 1, a metal substrate sample exhibiting a rotation endurance number twice or more that of a monolayer metal substrate sample (comparative sample 7) was rated with “OO,” and a metal substrate sample exhibiting a rotation endurance number 1.5 times or more that of a monolayer metal substrate sample (comparative sample 7) was rated with “O.” A metal substrate sample exhibiting a rotation endurance number which was more than that of a monolayer metal substrate sample (comparative sample 7) and which was 40,000 or less was rated with “Δ.” A metal substrate sample exhibiting a rotation endurance number less than that of a monolayer metal substrate sample (comparative sample 7) was rated with “X.”

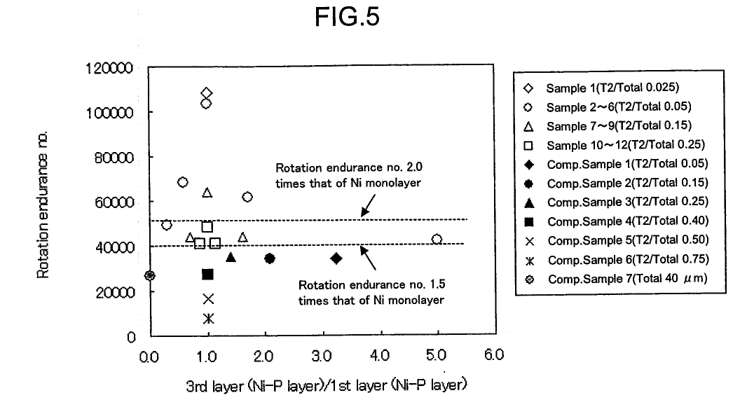

FIG. 5 is a graph showing the relationship between the rotation endurance number of a metal substrate, and the ratio of the thickness of the third layer to that of the first layer.

As shown in FIG. 5, metal substrate comparative samples 1 to 7 broke after about 8,000 to 40,000 swing cycles. Metal substrate samples 1 to 12 did not break after 40,000 swing cycles (samples 10 and 12), and some of them did not break after 100,000 swing cycles (samples 1 and 4). Metal substrate samples 1 to 12 (thickness: about 40 μm) exhibited a rotation endurance number 1.5 times or more that of a monolayer metal substrate sample having a thickness of 40 μm (comparative sample 7). Thus, metal substrate samples 1 to 12 did not readily undergo breakage due to bending stress and had improved durability. Particularly, metal substrate samples 1, 3, 4, 5, and 8 (thickness: 40 μm) exhibited a rotation endurance number twice or more that of a monolayer metal substrate sample having a thickness of 40 μm (comparative sample 7). Thus, metal substrate samples 1, 3, 4, 5, and 8 were found to have further improved durability.

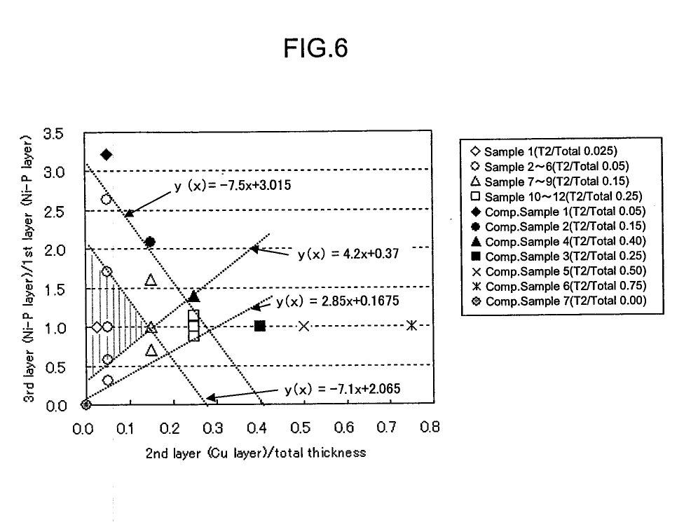

FIG. 6 is a graph showing the relationship between the ratio (y) of the thickness of the third layer (Ni—P layer) to that of the first layer (Ni—P layer) of each metal substrate and the ratio (x) of the thickness of the second layer (Cu layer) to the total thickness of the metal substrate.

In Test Example 1, metal substrate samples 1 to 12, which exhibited a rotation endurance number 1.5 times or more that of a monolayer metal substrate sample having a thickness of 40 μm (comparative sample 7), were found to satisfy the relationship between the ratio (y) of the thickness of the third layer to that of the first layer and the ratio (x) of the thickness of the second layer to the total thickness of the metal substrate: y(x)≦—7.5x+3.015 (formula 1). Particularly, when the ratio (y) of the thickness of the third layer to that of the first layer satisfied the aforementioned formula 1 and formula 2: y(x)≦2.85x+0.1675, the rotation endurance number of the metal substrate reliably increased, leading to improvement in durability. Notably, comparative sample 7, composed only of a first layer, falls outside the scope of the present invention.

Furthermore, metal substrate samples 1, 3, 4, 5, and 8, which exhibited a rotation endurance number twice or more that of a monolayer metal substrate sample having a thickness of 40 μm (comparative sample 7), were found to satisfy the relationship between the ratio (y) of the thickness of the third layer to that of the first layer and the ratio (x) of the thickness of the second layer to the total thickness of the metal substrate: y(x)≦−7.1x+2.065 (formula 3) and y(x)≧4.2x+0.37 (formula 4). Particularly, when the ratio (y) of the thickness of the third layer to that of the first layer satisfied the aforementioned formulas 3 and 4, the rotation endurance number of the metal substrate further increased, leading to further improvement in durability. Also, the test of sample 1 has revealed that, when the ratio (x) of the thickness of the second layer to the total thickness of the metal substrate is 0.025 or more, the effects of the present invention can be attained.

What is claimed is:

1. A multilayer metal member for image fixation comprising a metal substrate formed of at least three laminated metal layers, and a fluororesin layer disposed on the metal substrate,
wherein the metal substrate has a first layer which is an electrocast seamless belt formed of nickel or a nickel alloy, a second layer which is an electrocast seamless belt formed of a metal having a Young's modulus smaller than that of the first layer, and a third layer formed of a metal having a corrosion resistance higher than that of the second layer; and
the ratio (y) of the thickness of the third layer to that of the first layer satisfies the following formula 1:
y(x)≦−7.5x+3.015,
including the ratio (x) of the thickness of the second layer to the total thickness of the metal substrate.

2. A multilayer metal member for image fixation according to claim 1,
wherein the second layer is a plating layer formed of copper or a copper alloy.

3. A multilayer metal member for image fixation according to claim 1,
wherein the third layer is a plating layer formed of nickel or a nickel alloy.

4. A multilayer metal member for image fixation according to claim 1,
wherein the metal substrate has a laminate structure in which the second layer is sandwiched by the first layer and the third layer.

5. A multilayer metal member for image fixation according to claim 1,
which further has an elastic layer disposed on the metal substrate.
